(19) United States
(12) Patent Application Publication
(10) Pub. No.: US 2008/0221253 A1
(43) Pub. Date: Sep. 11, 2008

(54) Lipophilic Properties of 2-Acrylamido-2-Methylpropanesulfonic Acid

(75) Inventors: Joseph G. Seebauer, Wickliffe, OH (US); Kathleen O. Havelka, Mentor, OH (US); Richard M. Lange, Euclid, OH (US)

Correspondence Address: THE LUBRIZOL CORPORATION;ATTN: DOCKET CLERK, PATENT DEPT., 29400 LAKELAND BLVD., WICKLIFFE, OH, 44092, US

(73) Assignee: THE LUBRIZOL CORPORATION, Wickliffe, OH (US)

(21) Appl. No.: 10/598,084

(22) PCT Filed: Feb. 9, 2005
(86) PCT No.: PCT/US2005/004198

§ 371 Date: Oct. 26, 2006

Related U.S. Application Data
(60) Provisional application No. 60/546,117, filed on Feb. 19, 2004.

(51) Int. Cl. C08F 2/22

(52) U.S. Cl. 524/458

(57) ABSTRACT

The lipophilic properties of an ethylenically unsaturated water-soluble polymerizable sulfonic acids are improved by forming a salt thereof with a lipophilic amine. Such salts are readily polymerized in an emulsion or solution process.

### FIELD OF THE INVENTION

The present invention relates to a method for improving the lipophilic properties of certain ethylenically unsaturated water-soluble monomers. Specifically, the invention relates to a method for improving the lipophilic properties of ethylenically unsaturated water-soluble sulfonic acid monomers. Further, this improvement will result in sulfonic acid monomers with enhanced compatibility with lipophilic, water-insoluble solvents and monomers. The enhanced compatibility will result in improved incorporation of the sulfonic acid monomer into emulsion polymers and lipophilic, solvent-based solution polymers. The improved sulfonic acid monomer incorporation will give benefits such as improved thermal stability, improved divalent cation resistance, improved pH stability, and improved mechanical stability to the emulsion polymers and lipophilic, solvent-based, water-insoluble, solution polymers containing it.

### BACKGROUND OF THE INVENTION

Hydrophilic monomers such as certain ethylenically unsaturated water-soluble sulfonic acid monomers bring specific, beneficial properties such as, but not limited to, hydrophilicity, improved divalent cation stability, improved thermal stability, ionic strength, and polarity to polymers in which they are incorporated. These sulfonic acid monomers are well known; for example, 2-acrylamido-2-methylpropanesulfonic acid and its salts are well known materials which are commercially available under the trade name AMPS® monomers. Such materials and their methods of preparation are disclosed, for instance, in U.S. Pat. No. 3,544,597. However, they are limited in their polymer applicability because of their poor lipophilic properties. They are not appreciably soluble in lipophilic solvents such as toluene or in lipophilic, water-insoluble monomers such as styrene or butyl acrylate. These poor lipophilic properties result in poor sulfonic acid monomer incorporation in polymers made in lipophilic solvents, thus limiting the beneficial properties derived from the sulfonic acid monomer.

In the process of incorporating ethylenically unsaturated water-soluble sulfonic acid monomers into polymer backbones of polymers made via emulsion polymerization, the poor lipophilic properties of the ethylenically unsaturated water-soluble sulfonic acid monomer limit its incorporation into the emulsion polymer backbone typically composed of lipophilic, water-insoluble monomers such as styrene or butyl acrylate. This limits the beneficial properties, as described above, that the emulsion polymer could have.

U.S. Pat. No. 6,331,647, Quinn et al., Dec. 18, 2001, discloses a process for the preparation of a purified acrylamide sulfonic acid monomer derivative. An aqueous solution of a metal oxide or hydroxide or an amine of the structure NR₃R₄R₅ is reacted with the impure monomer, and recovering a purified salt by crystallization. When R₃, R₄, and R₅ are alkyl groups, an illustrative list provided includes (among others) decyls, undecyl, and docdecyls. Examples of the above amines include trimethylamine and ethylamine, among others (see Table II). Other amines can be of the structure R₃R₄NR₆NR₇ where R₆ is an alkylene group and R₇ is, e.g., R₃R₄.

U.S. Pat. No. 4,552,939, Thaler et al., Nov. 12, 1985, discloses preparation of sulfonated copolymers by a suspension copolymerization process wherein an unsulfonated monomer is copolymerized with a sulfonated monomer such as the trioctylammonium salt of acrylamidomethylpropanesulfonic acid. Suitable amines must have alkyl groups less than 10 carbons in the longest segment of any chain an must contain a total of more than 16 carbons. If the chain length of the alkyl groups on the amine are too long, an emulsion is obtained instead of a filterable suspension. The trioctylammonium salt of AMPS is prepared by adding AMPS to toluene and adding this slurry to trioctylamine in toluene.

It would be desirable if there were a method for improving the lipophilic properties of ethylenically unsaturated water-soluble sulfonic acid monomers. The improved sulfonic acid monomers would then have improved incorporation into lipophilic solution polymers and emulsion polymers leading to enhanced beneficial properties brought to the polymer by the sulfonic acid monomer unit.

### SUMMARY OF THE INVENTION

The present invention provides a method for improving the lipophilic properties of ethylenically unsaturated, water-soluble sulfonic acid monomers such as 2-acrylamido-2-methylpropanesulfonic acid, by forming salts of the ethylenically unsaturated, water-soluble sulfonic acid monomers with lipophilic amines. More specifically, it provides a process for incorporating an ethylenically unsaturated water-soluble polymerizable sulfonic acid monomer into an emulsion polymer, comprising:

(A) adding 0.2 to 60 weight percent, based on the total monomers, of a lipophilic amine salt of said ethylenically unsaturated water-soluble polymerizable sulfonic acid monomer to a latex formulation of at least one polymerizable monomer, which latex formulation comprises (a) at least one substantially water-insoluble lipophilic monomer other than said lipophilic amine salt, (b) water, and (c) a polymerization initiator; and

(B) polymerizing the monomers in the latex formulation.

Additionally, the present invention provides a process for incorporating an ethylenically unsaturated water-soluble polymerizable sulfonic acid monomer into an organic solvent-soluble polymer, comprising

(A) adding 0.2 to 60 weight percent, based on the total monomers, of a lipophilic amine salt of said ethylenically unsaturated water-soluble polymerizable sulfonic acid monomer to a formulation which comprises (a) a liquid medium selected from the group consisting of (i) organic solvents and (ii) lipophilic monomers other than said lipophilic amine salt, and (iii) mixtures thereof, and (b) a polymerization initiator; and

(B) polymerizing the monomers in said formulation.

The improved lipophilic properties of the sulfonic acid monomer will lead to improved incorporation thereof into emulsion polymers and lipophilic, solvent based polymers. Said improved incorporation will give certain benefits to the emulsion polymers and lipophilic solvent based polymers. Benefits such as improved thermal stability, improved divalent cation stability, improved mechanical stability, improved pH stability, and improved adhesion, have long been desired by those skilled in the art. However, these benefits have been difficult to achieve due to the poor lipophilic properties of the ethylenically unsaturated, water-soluble sulfonic acid monomers and their metallic salts. The poor lipophilic properties limit the use of ethylenically unsaturated, water-soluble sulfonic acid monomers in solvent based polymers and their incorporation into emulsion polymers.

The present invention also provides a process for improving incorporation of ethylenically unsaturated water-soluble polymerizable sulfonic acid into an emulsion polymer by adding the lipophilic amine salt of said ethylenically unsaturated water-soluble polymerizable sulfonic acid to a latex formulation. The process comprises the steps of (i) combining (a) a lipophilic monomer mixture consisting of one or more water-insoluble lipophilic monomers, (b) optionally an anionic surfactant, (c) 0.5 to about 40 weight percent, based on the total monomers, of a lipophilic amine salt of an ethylenically unsaturated water-soluble polymerizable sulfonic acid, (d) water, (e) a polymerization initiator, (f) optionally an ethylenically unsaturated water-soluble polymerizable non-ionic monomer, (g) optionally a chain transfer agent, and (h) optionally a buffer; and (i) heating the mixture to an appropriate temperature to effect the polymerization.

The present invention, therefore, solves the problem of incorporating a greater proportion of ethylenically unsaturated, water-soluble sulfonic acid monomers into lipophilic solvents for a variety of uses including polymerization with ethylenically unsaturated lipophilic water-insoluble monomers, as well as the problem of poor incorporation into emulsion polymers made with ethylenically unsaturated lipophilic water-insoluble monomers, by forming salts of the ethylenically unsaturated, water-soluble sulfonic acid monomers with lipophilic amines and using said salts in said various uses including polymerization.

### DETAILED DESCRIPTION OF THE INVENTION

Various features and embodiments will be described below by way of non-limiting illustration.

The method for improving the lipophilic properties of ethylenically unsaturated, water-soluble sulfonic acid monomers involves forming a salt of the sulfonic acid monomer with a lipophilic amine. This salt can then be used in a polymerization process, either an emulsion polymerization or a solvent based polymerization, both of which typically use water-insoluble monomers to polymerize with the sulfonic acid monomer. A solvent based polymerization will typically be used to prepare an organic solvent-soluble polymer. The terms polymer, polymerize, and polymerization, as used herein, are intended to broadly include polymer chains of two, three or more monomers, typically called copolymers, terpolymers, etc., and the reactions and processes to form these materials from mixtures of two, three or more ethylenically unsaturated monomers.

The ethylenically unsaturated, water-soluble sulfonic acid monomers usable in the present invention include polymerizable sulfonic acids such as unsaturated hydrocarbylamidoalkanesulfonic acids, for example, acrylamido- or methacrylamidosulfonic acids represented by the formulas:

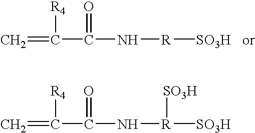

wherein R₄ is a hydrogen or a methyl group and R is an aliphatic or aromatic hydrocarbon group typically containing 2 to 8 carbon atoms. In one embodiment, the ethylenically unsaturated water-soluble polymerizable sulfonic acid can be an unsaturated-hydrocarbylamido-alkanesulfonic acid. In the above structures, the R group can be branched, as in the molecule 2-acrylamido-2-methylpropanesulfonic acid, which has the following structure:

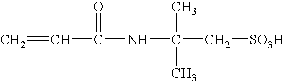

The R group can also include phenyl groups, alkyl substituted phenyl groups and cycloaliphatic groups.

The salts are selected from the group consisting of lipophilic amine salts. The amine ion, that is, the amine in its cationic form, can be represented by:

R₅R₆R₇R₈N⁺

where R₅, R₆, R₇ , and R₈ are independently hydrogen or hydrocarbyl groups, provided that at least one of R₅, R₆, R₇, and R₈ is a hydrocarbyl group of sufficient length suitable to impart lipophilic properties. The term “amine salt” or “amine ions” includes ions or salts, where up to three of the R groups are hydrocarbyl groups, and quaternary amine ions or salts, where each of the R groups is a hydrocarbyl group. In order to provide suitable lipophilic character, the total carbon atoms in the amine ion should be at least 6, and in one embodiment at least 10, or at least 14. In certain embodiments, the total number of carbon atoms in an amine cation does not exceed 36 carbon atoms; thus the total number of carbon atoms may be, e. g., 6 to 36. Examples of suitable amines include N,N-dimethyl-n-dodecylamine, 2-ethylhexylamine, tri-n-butylamine, triisobutylamine, triisooctylamine, tripropylamine, trihexylamine, trioctylamine, decylamine, dodecylamine, tridecylamine, tridodecylamine, hexadecylamine, octadecylamine, oleylamine, higher tert-alkyl primary amines such as Primene 81R™ and Primene JMT™ from Rohm and Haas, and aromatic amines such as pyridines, benzylamine, N-methylbenzylamine, 2-phenethylamine, aniline, and substituted anilines.

As used herein, the term “lipophilic” is given its conventional meaning, that is, interacting favorably with or being soluble in non-polar or fatty solvents. A synonym for “lipophilic” is “hydrophobic,” which may be contrasted with “hydrophilic.” Hydrophobic materials exhibit little or no favorable interaction with water and are generally not appreciably soluble in water or similarly polar solvents. The hydrophobic or hydrophilic character of a material can also be understood to approximately correlate with results derived from the octanol/water partition test. The original form of this test, involving measurement of the equilibrium concentration of a dissolved substance in a two-phase system of n-octanol and water, as well as a chromatographic method, are described in ASTM E-1147-92. P=C_{octanol}/C_{water}. The hydrophilic or hydrophobic nature of an amine in question can be evaluated by comparing its P value with the P values of other amines, as those listed above, which are known to be appropriately lipophilic materials. For many hydrophobic chemicals, log P is greater than 0.8, more commonly 0.9 or greater. That of ethylbenzene, as an example, is about 3.1. A listing of log P values of many chemicals as well as a theoretical discussion of partition coefficients can be found in Leo et al., Chemical Reviews, 71, 6, pp. 528-616 (1971).

In contrast, “water-soluble” monomers are those that exhibit sufficient solubility in water to benefit from the present invention. Such materials, untreated, typically exhibit at least 1% by weight solubility in water at room temperature, or at least 5% or at least 10% solubility, and a corresponding lack of solubility in an oil or hydrocarbon medium, e.g., less than 1% or less than 0.1% by weight solubility in, for instance, cyclohexane. Water-soluble monomers will also typically have a relatively low value of log P, as described above. For many hydrophilic chemicals, log P is about 0.8 or less, commonly 0.7 or less. That of acrylic acid, for instance, a water-soluble monomer, is about 0.4. (Likewise, “water-insoluble” monomers will typically exhibit relatively lesser solubility, e.g., less than 5% by weight solubility in water at room temperature, or less than 2% or 1% or 0.5% or even less than 0.1% or 0.01% and will typically have a relatively higher value of log P.)

Alternatively, the ethylenically unsaturated, water-soluble sulfonic acid monomer can be a styrenic sulfonic acid, which terms include styrene sulfonic acids and styrene sulfonates as well as substituted styrene sulfonic acids and substituted styrene sulfonates. Such materials, in their salt form, are illustrated by the following formula:

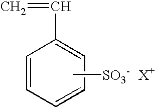

In the above structure, the X⁺ is a cation which is an amine ion as described above.

Other suitable sulfonic acid monomers include sulfoethyl methacrylate, isobutylenesulfonic acid, allylsulfonic acid, vinylsulfonic acid, and amine salts thereof as described above.

The salt of the water-soluble sulfonic acid and the lipophilic amine can be prepared by any conventional means, such as by the acid-base neutralization reaction of the sulfonic acid and the amine. For example, the sulfonic acid may be added to the amine in the presence or absence of solvent, or the amine can be added to the sulfonic acid monomer which may typically be suspended, slurried, or dissolved in a solvent which can be a monomer. Alternatively, such salts can be obtained by the combination of a metal salt of the sulfonic acid with another salt (e.g., a halide) of the amine. In the latter case, a metal salt, e.g., a metal halide, will be present as a byproduct, which may be permissible or may be undesirable, depending on the requirements of the polymerization system in which the monomers are to be employed. Preparation of the salts of the present invention can be performed in advance of their use in a polymerization reaction, optionally with removal of any byproducts, or the preparation can be in situ, by addition of the reactants to the polymerization mixture.

The above sulfonic acid monomers are commonly polymerized with one or more lipophilic, water-insoluble monomers. The lipophilic, water-insoluble monomer can be an olefin, such as an alpha olefin, of 6 to 18 carbon atoms. Aliphatic alpha olefins of this type include 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, and 1-octadecene, including both linear isomers and branched isomers such as 2-ethylhex-1-ene, and mixtures of linear and branched olefins as may be commercially available.

The lipophilic, water-insoluble monomer can also be a vinyl arene such as styrene (which can also be considered an alpha olefin) or any of the hydrocarbyl-substituted styrenes. Such materials can typically be represented by the formula

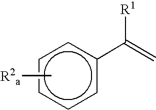

In the foregoing structure, R¹ is hydrogen or a hydrocarbyl group, R² is a hydrocarbyl group, and “a” is zero through 5, such as zero or 1. R¹, if it is a hydrocarbyl group, and R² can, in one embodiment, each contain 1 to 18 carbon atoms, in another embodiment 1 to 12, and in yet another embodiment 1 to 4, and the total number of such hydrocarbyl substituents can be, for instance, zero to 3, in one embodiment 0 or 1, and in another embodiment 0. In addition to the structure shown, with the R¹ group on the carbon shown above, it is also possible to have a hydrocarbyl group on the other carbon of the double bond. Such materials are intended to be encompassed by the present invention, although they may be less desirable in some applications due to the reduced polymerization activity of materials containing only internal ethylenic bonds. Similarly, the expression “hydrocarbyl-substituted styrene” is intended to encompass structures in which the R² group provides a fused ring structure, that is, in which the overall material is a vinyl naphthalene compound or a hydrocarbyl-substituted derivative thereof. In the latter case, the value of “a” can be up to the number of replaceable hydrogen atoms on the ring structure. Among these alternatives, styrene itself may be selected as a monomer.

The lipophilic, water-insoluble monomer can also be an acrylate ester of the following formula:

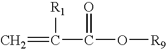

where R₁ is a hydrogen or a methyl group and R₉ is a hydrocarbyl group containing 1 to 22 carbon atoms. Examples include methyl acrylate, methyl methacrylate, butyl acrylate, and 2-ethylhexylacrylate.

The lipophilic, water-insoluble monomer can also be an alkyl substituted acrylamide compound having the formula:

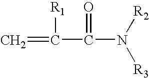

where R₁ is a hydrogen or a methyl group and R₂ and R₃ are independently hydrogen or hydrocarbyl groups, provided that R₂ and R₃ are not both methyl, and the total number of carbon atoms in R₂ and R₃ combined is 2 to 36. Suitable materials include N-phenylacrylamide, N-tert-butylacrylamide, N,N-dibutylacrylamide, N-dodecylacrylamide, and N-octadecylacrylamide.

Additional comonomers of various types can optionally be present, provided that, at their given concentration they do not interfere with the effectiveness of the present invention. For example, water-soluble monomers generally may be readily polymerizable under certain conditions with 2-acrylamido-2-methylpropanesulfonic acid monomer even in the absence of the present invention, and thus the benefits of the present invention may not be fully expressed. The amounts of such materials should be correspondingly limited. Alternatively, under other polymerization conditions the water-soluble monomers may not be polymerizable at all and should be avoided entirely. However, various amount of one or more water-soluble monomers may optionally be present in an emulsion polymerization. Typical monomers that can be present, in greater or lesser amounts, as the case may be, can include such ethylenically unsaturated water-soluble polymerizable ionic or non-ionic monomers as acrylic acid, acrylamide, N-methyl acrylamide, N,N-dimethylacrylamide, methacrylic acid, N-vinylpyrrolidone, 2-hydroxyethyl methacrylate, 2-hydroxypropyl methacrylate, and sulfonic acid monomers or salts thereof such as 2-acrylamido-2-methylpropanesulfonic acid or its metal salt, e.g., sodium salt.

In the polymerization reaction the ethylenic bonds in the styrene or other lipophilic, water-insoluble monomer and in the ethylenically unsaturated, water-soluble polymerizable sulfonic acid monomer polymerize to yield the resulting polymer.

Examples of solution polymers include poly[styrene-co-2-acrylamido-2-methylpropanesulfonic acid 2-ethylhexylamine salt], polymethylmethacrylate-co-2-acrylamido-2-methylpropanesulfonic acid N,N-dimethyl-n-dodecylamine salt, poly[ethylacrylate/styrene/2-acrylamido-2-methylpropanesulfonic acid 2-ethylhexylamine salt], poly[butylacrylate/vinyl acetate/2-acrylamido-2-methylpropanesulfonic acid N,N-dimethyl-n-dodecylamine salt], polylaurylmethacrylate-co-2-acrylamido-2-methylpropanesulfonic acid tri-n-butylamine salt, poly[styrene/maleic anhydride/methyl methacrylate/2-acrylamido-2-methylpropanesulfonic acid 2-ethylhexylamine salt], and poly[1-decene/maleic anhydride/2-acrylamido-2-methylpropanesulfonic acid trioctylamine salt].

Examples of emulsion polymers include, polymethyl methacrylate/butyl acrylate/2-acrylamido-2-methylpropanesulfonic acid N,N-dimethyl-n-dodecylamine salt, polybutyl acrylate/2-ethylhexyl acrylate/2-acrylamido-2-methylpropanesulfonic acid 2-ethylhexylamine salt, polystyrene-co-2-acrylamido-2-methylpropanesulfonic acid trioctylamine salt, polyvinyl acetate-co-2-acrylamido-2-methylpropanesulfonic acid 2-ethylhexylamine salt, poly-ethylacrylate/styrene/methacrylic acid/2-acrylamido-2-methylpropanesulfonic acid tri-n-butylamine salt, and polybutyl acrylate/vinyl acetate/2-acrylamido-2-methylpropanesulfonic acid N,N-dimethyl-n-dodecylamine salt.

The polymerization reaction itself can be a solution polymerization in a hydrophobic medium, or an emulsion polymerization in an aqueous medium. As a variation of solution polymerization, precipitation polymerization has been described in, e.g., U.S. Pat. No. 5,475,047. Any of such polymerizations can be performed in a batchwise, continuous, or semicontinuous manner.

For solution polymerizations, the hydrophobic medium or solvent can typically be toluene, xylenes, or hexanes. Lesser amounts of polar solvents, such as alcohols or ethers, may also be present. The concentration of the salt of the lipophilic amine can typically be 0.2 to 60%, or 0.5% to 50%, or 1 to 20%, or 2 to 10% by weight. Typical catalysts or initiators can include benzoyl peroxide, various peroxyesters, and 2,2′-azobis-(2-methylbutryonitrile), which can be used in amounts of 0.10% to 2%, to 0.05% to 5% by weight. Other materials which can be present include foam control agents and chain transfer agents. Chain transfer agents are well known to those skilled in the art of polymerization and include such materials as mercaptans. The polymerization is typically conducted by heating the reaction mixture, at a temperature of typically at least 30° C. The reaction is typically conducted at 40 to 140° C., alternatively, 50-110° C., for 1.5 to 8 hours. Alternatively, the polymerization can be effected by employing a redox reaction. Conditions for solution polymerizations and variations thereof to suit particular needs and circumstances are within the abilities of those skilled in the art.

For emulsion polymerizations, the medium is typically water or a predominantly water mixture. The concentration of the salt of the lipophilic amine can typically be 0.1% or 0.2% to 60% or to 50%, or 0.5 to 40%, or 1 to 20% by weight. Typical catalysts or initiators can include sodium persulfate, potassium persulfate, ammonium persulfate, alkylperoxydicarbonates, and 2,2′-azobis(2-amidinopropane) dihydrochloride, and can be used in amounts of 0.01% to 2.5% or 0.05% to 1% by weight. Other materials which can be present include chain transfer agents, surfactants, foam control agents, buffers, and emulsifiers. (Some of the amine salts of the present invention may themselves be emulsifiers.) The surfactant or surfactants which may optionally be employed include anionic surfactants, cationic surfactants, non-ionic surfactants, and zwitterionic surfactants, examples of each of such types being well known to those of ordinary skill in the art. The polymerization reaction is typically conducted by heating the reaction mixture, at a temperature of, for instance 30° C. or 40° C. to 90° C., or 40° C. to 75° C., or 50° C. to 80° C., for 1.5 to 8 hours. Alternatively, the polymerization can be initiated by employing a redox reaction. Conditions for emulsion polymerizations and variations thereof to suit particular needs and circumstances are within the abilities of those skilled in the art.

Polymers thus prepared can be used in the formation of adhesives, coatings, inks, fillers, or caulks. Such materials typically comprise (a) a resin binder, such as a phenol formaldehyde resin, a urea formaldehyde resin, a melamine formaldehyde resin, or combinations thereof; (b) an emulsion polymer containing the lipophilic amine salt of an ethylenically unsaturated water-soluble polymerizable sulfonic acid, as described above, and (c) optionally an organic solvent and/or water, in conventional amounts that are well known to the person skilled in the art.

### EXAMPLES

### Example 1

### Amine Salt

Mix 24.8 grams of 2-acrylamido-2-methylpropanesulfonic acid and 151 grams acetone together in a ½-L jar with an electrical stirrer to form a slurry. Add 25.6 grams of N,N-dimethyl-n-dodecylamine via pipette over 30 minutes, adding a portion about every five minutes. No significant temperature increase is noted during the amine addition and the reaction is run at about 18° C. (64° F.). The slurry starts to clear up at the end of the amine addition and all of the 2-acrylamido-2-methylpropanesulfonic acid is solubilized one hour after the amine addition is completed. Add 0.05 grams of para-methoxyphenol to the jar contents and the mixture is stirred another hour at room temperature. The jar contents are vacuum filtered through paper using a Büchner funnel. The filtrate is vacuum stripped of acetone and other volatiles using a rotary evaporator at 32° C. (90° F.) for 40 minutes. One obtains 50.4 grams of a clear viscous liquid. NMR analysis confirms the 2-acrylamido-2-methylpropanesulfonic acid/N,N-dimethyl-n-dodecylamine salt structure.

### Example 2

### Amine Salt

Mix 31.0 grams of 2-acrylamido-2-methylpropanesulfonic acid and 151 grams acetone together in a ½-L jar with an electrical stirrer to form a slurry. Add 19.4 grams of 2-ethylhexylamine via pipette over 30 minutes, adding a portion about every five minutes. A slight temperature increase (from 18° C. (64° F.) to 23° C. (74° F.)) is noted during the amine addition. The slurry starts to clear up at the end of the amine addition and all of the 2-acrylamido-2-methylpropanesulfonic acid is solubilized one hour after the amine addition is completed. Add 0.05 grams of para-methoxyphenol to the jar contents and the mixture is stirred another hour at room temperature. The jar contents are vacuum filtered through paper using a Buchner funnel. The filtrate is vacuum stripped using a rotary evaporator at 32° C. (90° F.) for 1.5 hours and 49° C. (120° F.) for 30 minutes. One obtains 52.4 grams of a clear light yellow viscous liquid. NMR analysis confirms the 2-acrylamido-2-methylpropanesulfonic acid/2-ethylhexylamine salt structure.

### Example 3

### Amine Salt

Mix 24.8 grams of 2-acrylamido-2-methylpropanesulfonic acid and 151 grams acetone together in a ½-L jar with an electrical stirrer to form a slurry. Add 22.2 grams of tri-n-butylamine via pipette over 30 minutes, adding a portion about every five minutes. No significant temperature increase-is noted during the amine addition and the reaction is run at about 18° C. (64° F.). The slurry starts to clear up at the end of the amine addition and all of the 2-acrylamido-2-methylpropanesulfonic acid is solubilized one hour after the amine addition is completed. Add 0.05 grams of para-methoxyphenol to the jar contents and stir the mixture another hour at room temperature. The jar contents are vacuum filtered through paper using a Buchner funnel. The filtrate is vacuum stripped of acetone and other volatiles using a rotary evaporator at 32° C. (90° F.) for 60 minutes. One obtains 46.8 grams of a semi-viscous pink liquid. NMR analysis confirms the 2-acrylamido-2-methylpropanesulfonic acid/tri-n-butylamine salt structure.

### Example 4

### Polymerization

A monomer mixture of methyl methacrylate (380 grams) and butyl acrylate (312 grams) is prepared. To a nitrogen-purged solution of sodium lauryl sulfate (0.36 grams) and sodium bicarbonate (1.4 grams) in 403 grams of water at 80° C. is added 10% of the monomer mixture and 2 grams of the 2-acrylamido-2-methylpropanesulfonic acid/N,N-dimethyl-n-dodecylamine salt prepared as in Example 1. After the temperature returns to 80° C., a solution of sodium persulfate (0.7 grams) in 10 grams of water is added. After 30 minutes, the remainder of the monomer mixture is added at a steady rate simultaneously adding 20 grams of the 2-acrylamido-2-methylpropanesulfonic acid/N,N-dimethyl-n-dodecylamine salt over the same time period. After 30 minutes of monomer addition, a solution of sodium persulfate (3.5 g, 14.7 mmol) in 140 g of water is added at a steady rate. When addition of all of the ingredients is complete, the resulting latex is stirred under nitrogen for an additional 30 minutes, decanted and cooled.

### Example 5

### Polymerization

To a two-liter 4-neck reaction flask equipped with a stirrer, nitrogen inlet, thermowell, addition funnel, and a water-cooled condenser is charged ⅓ by volume of a mixture of 288.5 grams of butyl acrylate, 138.2 grams of 2-ethylhexyl acrylate, 20 grams of the 2-acrylamido-2-methylpropanesulfonic acid/N,N-dimethyl-n-dodecylamine salt of Example 1, 3.0 grams of benzoyl peroxide, and 426.7 grams of toluene. The remaining ⅔ of the above mixture is charged to a one-liter addition funnel and purging of the flask with nitrogen is begun. Heat flask contents to 50° C. Within ten minutes, vigorous toluene reflux begins and the temperature increases to 110° C. Add the remaining monomer mixture over 1.5 hours while keeping the temperature at 110° C. Prepare a solution of 1.5 grams benzoyl peroxide in 15 grams toluene and charge this over 5 minutes. Hold the reaction for 2 hours at 110° C. while stirring. Cool to room temperature to obtain 890 grams of a clear, viscous polymer solution.

### Example 6

### Polymerization

To a two-liter, 4-neck reaction flask equipped with a stirrer, nitrogen inlet, thermowell, and water-cooled condenser is charged ethyl acetate (656.1 g), cyclohexane (558.9 g), acrylic acid (276.5 g), stearyl methacrylate (8.5 g) 2-acrylamido-2-methylpropanesulfonic acid/N,N-dimethyl-n-dodecylamine salt of Example 1 (20 g), allyl sucrose (1.7 g) and polyvinyl alcohol (8.5 g). The flask is placed in a constant temperature bath set at 50° C. Stirring is begun and the mixture purged with nitrogen for 30 minutes while the mixture reaches 50° C. Thereafter, initiator (di-(2-ethylhexyl)peroxydicarbonate, 0.5 g) is added. Within 5 minutes the solution becomes hazy as polymer precipitates out of solution. The mixture is maintained for a total of 8 hours at 50° C. while stirring, and then is cooled to room temperature. Solvent is removed by rotary evaporation, resulting in a white powder which is the product.

### Testing

The latex of Example 4 is tested for divalent cation tolerance. Testing is done for calcium coagulation by treating latex with a 5% by weight aqueous CaCl₂ solution. Five grams of the latex from Example 5 requires 40 mL of a 5 wt. % aqueous CaCl₂ solution for coagulation to take place. A latex with no sulfonic acid monomer, but acrylic acid monomer in its place, coagulates with only 1 mL of the 5 wt. % aqueous CaCl₂ solution.

Testing of the solubility of monomers is conducted by mixing 10% of the monomer with a variety of solvents. Results are shown in the following Table:

TABLE
Solubility Properties of 2-Acrylamido-2-methylpropanesulfonic acid/
Lipophilic Amine Salts (Solubility at 10% by weight in solvent)

| Example | 7 (comparative) | 8 | 9 | 10 |
|---|---|---|---|---|
| Material | 2-acrylamido-2- | Product of | Product of | Product of |
| | methyl-propane | Ex. 1 | Ex. 2 | Ex. 3 |
| | sulfonic acid | | | |
| Water | clear | clear | clear | clear |
| Isopropanol | not fully soluble | clear | clear | clear |
| Ethanol | insoluble | clear | clear | clear |
| Ethyl | insoluble | clear | clear | clear |
| Acetate | | | | |
| Butyl | insoluble | clear | trace oil | clear |
| Acetate | | | layer on | |
| | | | bottom | |
| Toluene | insoluble | clear | oil layer on | oil layer on |
| | | | bottom | bottom |
| Styrene | insoluble | clear | oil layer on | clear |
| | | | bottom | |

The results show improved solubility of monomers in solvents of decreasing polarity/increasing hydrophobic character when the salts prepared with hydrophilic amines are tested.

As used herein, the term “hydrocarbyl substituent” or “hydrocarbyl group” is used in its ordinary sense, which is well-known to those skilled in the art. Specifically, it refers to a group having a carbon atom directly attached to the remainder of the molecule and having predominantly hydrocarbon character. Examples of hydrocarbyl groups include:

hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form a ring);

substituted hydrocarbon substituents, that is, substituents containing non-hydrocarbon groups which, in the context of this invention, do not alter the predominantly hydrocarbon substituent (e.g., halo (especially chloro and fluoro), hydroxy, alkoxy, mercapto, alkylmercapto, nitro, nitroso, and sulfoxy);

hetero substituents, that is, substituents which, while having a predominantly hydrocarbon character, in the context of this invention, contain other than carbon in a ring or chain otherwise composed of carbon atoms. Heteroatoms include sulfur, oxygen, nitrogen, and encompass substituents as pyridyl, furyl, thienyl and imidazolyl. In general, no more than two, or in one embodiment no more than one, non-hydrocarbon substituent will be present for every ten carbon atoms in the hydrocarbyl group; typically, there will be no non-hydrocarbon substituents in the hydrocarbyl group.

It is known that some of the materials described above may interact in the final formulation, so that the components of the final formulation may be different from those that are initially added. For instance, metal ions can migrate to other acidic sites of other molecules. The products formed thereby, including the products formed upon employing the composition of the present invention in its intended use, may not susceptible of easy description. Nevertheless, all such modifications and reaction products are included within the scope of the present invention; the present invention encompasses the composition prepared by admixing the components described above.

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about.” Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil which may be customarily present in the commercial material, unless otherwise indicated. It is to be understood that the upper and lower amount, range, and ratio limits set forth herein may be independently combined. As used herein, the expression “consisting essentially of” permits the inclusion of substances which do not materially affect the basic and novel characteristics of the composition under consideration.

What is claimed is:

1. A process for incorporating an ethylenically unsaturated water-soluble polymerizable sulfonic acid monomer into an emulsion polymer, comprising:
(A) adding about 0.2 to about 60 weight percent, based on the total monomers, of a lipophilic amine salt of said ethylenically unsaturated water-soluble polymerizable sulfonic acid monomer to a latex formulation of at least one polymerizable monomer, which latex formulation comprises
(a) at least one substantially water-insoluble lipophilic monomer other than said lipophilic amine salt,
(b) water, and
(c) a polymerization initiator; and
(B) polymerizing the monomers in the latex formulation.

2. The process of claim 1 wherein the ethylenically unsaturated water-soluble polymerizable sulfonic acid monomer comprises an unsaturated hydrocarbylamidoalkanesulfonic acid.

3. The process of claim 1 where the ethylenically unsaturated water-soluble polymerizable sulfonic acid monomer is selected from the group consisting of acrylamidosulfonic acids and methacrylamidosulfonic acids represented by the formulas: 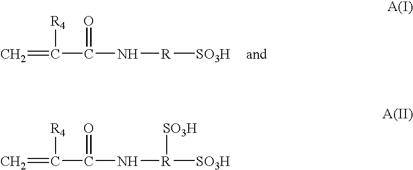
wherein R₄ is a hydrogen or a methyl group and R is an aliphatic or aromatic hydrocarbon group.

4. The process of claim 1 where the ethylenically unsaturated water-soluble polymerizable sulfonic acid monomer comprises 2-acrylamido-2-methylpropanesulfonic acid.

5. The process of claim 1 where the ethylenically unsaturated water-soluble polymerizable sulfonic acid is selected from the group consisting of styrenic sulfonic acid and substituted styrene sulfonic acids.

6. The process of claim 1 wherein the lipophilic amine comprises a material represented, in its cationic form, by:
R₅R₆R₇R₈N⁺
where R₅, R₆, R₇, and R₈ are independently hydrogen or hydrocarbyl groups, provided that at least one of R₅, R₆, R₇ and R₈ is a hydrocarbyl group.

7. The process of claim 6 wherein the total number of carbon atoms in R₅, R₆, R₇ and R₈ is about 6 to about 36.

8. The process of claim 1 where the lipophilic amine comprises N,N-dimethyl-n-dodecyl amine.

9. The process of claim 1 where said ethylenically unsaturated water-soluble polymerizable sulfonic acid monomer comprises 2-acrylamido-2-methylpropanesulfonic acid and the lipophilic amine comprises N,N-dimethyl-n-dodecyl amine.

10. The process of claim 1 wherein the latex formulation further comprises at least one component selected from the group consisting of surfactants, chain transfer agents, and buffers.

11. The process of claim 1 wherein the latex formulation further comprises an ethylenically unsaturated water-soluble polymerizable non-ionic monomer.

12. The process of claim 11 wherein the ethylenically unsaturated water-soluble polymerizable sulfonic acid comprises 2-acrylamido-2-methyl-propanesulfonic acid, the lipophilic amine comprises N,N-dimethyl-n-dodecyl amine and wherein the ethylenically unsaturated water-soluble polymerizable non-ionic monomer is present and comprises acrylamide.

13. The process of claim 1 wherein the amount of the lipophilic amine salt is about 0.5 to about 40 weight percent

14. The process of claim 1 wherein the polymerization is effected by heating the latex formulation to a temperature of about 30° C. to about 90° C.

15. An adhesive, coating, ink, filler, or caulk composition comprising the product of the process of claim 1.

16. An adhesive, coating, ink, filler, or caulk composition comprising an emulsion polymer comprising a lipophilic amine salt of an ethylenically unsaturated water-soluble polymerizable sulfonic acid monomer moiety.

17. The composition of claim 16 further comprising a resin binder.

18. The composition of claim 17 wherein said resin binder comprises a phenol formaldehyde resin, a urea formaldehyde resin, a melamine formaldehyde resin, or combinations thereof.

19. The composition of claim 16 further comprising an organic solvent or water or a mixture thereof.

20. A process for incorporating an ethylenically unsaturated water-soluble polymerizable sulfonic acid monomer into an organic solvent-soluble polymer, comprising
(A) adding about 0.2 to about 60 weight percent, based on the total monomers, of a lipophilic amine salt of said ethylenically unsaturated water-soluble polymerizable sulfonic acid monomer to a formulation which comprises
(a) a liquid medium selected from the group consisting of (i) organic solvents and (ii) lipophilic monomers other than said lipophilic amine salt, and (iii) mixtures thereof, and
(b) a polymerization initiator; and
(B) polymerizing the monomers in said formulation.

21. The process of claim 20 where the ethylenically unsaturated water-soluble polymerizable sulfonic acid comprises 2-acrylamido-2-methylpropanesulfonic acid and the lipophilic amine comprises N,N-dimethyl-n-dodecyl amine.

22. The process of claim 20 wherein the liquid medium comprises an organic solvent.

23. The process of claim 20 wherein the liquid medium comprises a lipophilic monomer.

24. The process of claim 20 wherein the formulation further comprises a chain transfer agent.

25. An adhesive, coating, ink, filler, or caulk composition comprising the product of the process of claim 20.
